(19) United States
(12) Patent Application Publication
(10) Pub. No.: US 2005/0208998 A1
(43) Pub. Date: Sep. 22, 2005

(54) Medal acceptance device

(76) Inventor: Hirobumi Toyoda, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/083,100

(22) Filed: Mar. 18, 2005

(30) Foreign Application Priority Data
Mar. 19, 2004 (JP) 2004-081201

(51) Int. Cl. A63F 13/00

(52) U.S. Cl. 463/25

(57) ABSTRACT

In the medal acceptance device 2, the value setting IC medal 66 is inserted and the value data of the game IC medal 65 (credit number added per one game IC medal) stored in the electronic tag 74 embedded in the value setting IC medal 66 is read out by the electronic tag reader 105 (S4). And the value data of the game IC medal 65 stored in the RAM 103 is changed to the value data read out (S15). And when a predetermined number of the game IC medals 65 are inserted, the value data changed are restored to the default value data (s11).

### CROSS-REFERENCE TO THE RELATED APPLICATION(S)

This application is based upon and claims a priority from the prior Japanese Patent Application No. 2004-081201 filed on Mar. 19, 2004, the entire contents of which are incorporated herein by reference. This application is related to co-pending U.S. patent application entitled to “MEDAL ACCEPTANCE DEVICE”, the application being filed on even date herewith. The co-pending application is expressly incorporated herein by reference.

### BACKGROUND OF THE INVENTION

1. Field of the Invention

The present invention relates to a medal acceptance device installed with a gaming machine such as a slot machine, a roulette game machine and the like, and in particular relates to a medal acceptance device in which a value of a game medal can be easily changed by utilizing a value setting medal and a restoration device for restoring the changed value.

2. Description of Related Art

In a so-called medal game conducted in a slot machine, a roulette game machine, a card game machine and the like by using a medal as a game medium, a player buys or borrows plural medals in a medal lending machine and the player inserts the medal into the gaming machine, thereby the medal game is started. And if the player wins the medal game, a predetermined number of medals are paid out. Therefore, the player who can obtain many medals can continuously enjoy the games without newly buying or borrowing the medals. Here, in such medal game, a value of one medal is constantly fixed when such medal bought or borrowed in the medal lending machine is used in the gaming machine. Thus, a game number or a credit number based on which the player can play per money used for buying or borrowing medals is determined to a fixed value beforehand every a game arcade.

Taking the above situation into consideration, it is described in Unexamined Japanese Publication No. 2000-317128 a medal lending machine in which a payout number is stored in a payout memory table every a predetermined time range and the payout number is read out based on press of an operation button by a user, thereby medals can be paid out corresponding to the payout number. According to the medal lending machine, although the value of one medal which is used in the game cannot be changed, the medal payout number per money to buy the medals can be changed based on a day of the week or the time range, thereby collection efficiency of customers (players) can be further expected by changing the game number corresponding to which the player can play the games per money to buy the medals or credit.

However, in the medal lending machine described in Unexamined Japanese Publication No. 2000-317128, the medal payout number is always changed on the basis of the same day of the week or the same time range, according to the payout number memory table in which the payout number against money to buy the medals is stored. Therefore, the medal payout number cannot be changed at a voluntary timing by the game arcade and a troublesome operation is required when the payout number memory table itself is changed. Accordingly, if a device or system to change the payout number is installed in the game arcade, there is a fear that cost at the game arcade increases.

Further, in the medal lending machine shown in the above reference, a medal number corresponding to which medals can be bought or borrowed with a predetermined amount of money is changed and a value for one medal is not changed. Thus, when the payout number of medals is set larger and many medals are bought or borrowed, it becomes difficult to carry medals bought or borrowed and to secure a place for putting medals, thereby there is a fear that the player loses interest for conducting games. And since the game number or credit, according to which the player can play games with money for buying or borrowing medals, or credit is not changed based on a date and time that player plays games but based on a date and time that the player buys or borrows medals, it can predict the player who only buys or borrows medals when the payout number of medals is set larger. As a result, collection efficiency for collecting customers (players) is reduced.

### SUMMARY OF THE INVENTION

The present invention has been done to dissolve the above problems and has an object to provide a medal acceptance device in which a value for one medal in a game can be changed by only inserting a specific medal without a large device or system, thereby game characteristic is variegated and interest of a player for games can be increased and collection efficiency can be surely expected, and further a game number according to which the player can play with money for buying or borrowing medals or credit can be easily changed at a voluntary timing of a game arcade.

In order to accomplish the above object, according to one aspect of the present invention, it is provided a medal acceptance device having a medal detection device for detecting a game medal inserted from a medal insertion slot and a data memory device for storing first value data corresponding to a first value of the game medal,
the medal acceptance device comprising:
a value setting medal having a memory medium in which second value data different from the first value data stored in the data memory device are stored;
a data detection device for detecting the second value data stored in the memory medium of the value setting medal inserted from the medal insertion slot;
a data change device for changing the first value data stored in the data memory device to the second value data when the second value data of the value setting medal are detected by the data detection device; and
a data restoration device for restoring the second value data changed by the data change device and stored in the data memory device to the first value data after the first value data are changed to the second value data by the data change device.

According to the medal acceptance device of the present invention, since the first value data stored in the memory device are changed to the second value data when the second value data of the value setting medal are detected by the data detection device and the data restoration device for restoring the second value data to the first value data before changed, the value for one game medal utilized in a game can be changed for a predetermined time by only inserting the value setting medal without a large device or system, thereby interest of a player for games can be increased. Therefore, the player does not need to carry many medals, and since game characteristic is variegated by changing the value of the game medal, interest of the player for games can be further increased. In addition to this, a game arcade can easily change the value of the game medal at a voluntarily timing without consuming cost.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view showing an outline construction of a roulette game machine according to the first embodiment,

FIG. 2 is a plan view of the roulette game machine according to the first embodiment,

FIG. 3 is one example of a display image displayed on an image display device,

FIG. 4 is a perspective view of a medal acceptance device according to the first embodiment,

FIG. 5 is a plan view showing an outline figure of a game IC medal according to the first embodiment,

FIG. 6 is a sectional view of the game IC medal when sectioned along the A-A line in FIG. 5,

FIG. 7 is a schematic view showing a memory area of an electronic tag in the game IC medal according to the first embodiment,

FIG. 8 is a plan view showing an outline figure of a value setting IC medal according to the first embodiment,

FIG. 9 is a sectional view of the value setting IC medal when sectioned along the B-B line in FIG. 8,

FIG. 10 is a schematic view showing a memory area of an electronic tag in the value setting IC medal according to the first embodiment,

FIG. 11 is a block diagram schematically showing a control system of a roulette game machine according to the first embodiment,

FIG. 12 is a block diagram schematically showing a control system of a satellite according to the first embodiment,

FIG. 13 is a schematic view showing a memory area of a ROM in the medal acceptance device according to the first embodiment,

FIG. 14 is a schematic view showing a memory area of a RAM in the medal acceptance device according to the first embodiment,

FIG. 15 is a flowchart of a medal acceptance process program in the first embodiment

FIG. 16 is a block diagram schematically showing a control system of a satellite according to the second embodiment,

FIG. 17 is a schematic view showing a memory area of a ROM in the medal acceptance device according to the second embodiment, and

FIG. 18 is a schematic view showing a memory area of a RAM in the medal acceptance device according to the second embodiment.

### DETAILED DESCRIPTION OF THE PREFERRED EMBODIMENTS

Hereinafter, medal acceptance devices according to the first and second embodiments embodying the present invention will be described in detail with reference to the drawings. Here, the medal acceptance device according to the present invention is arranged and utilized with various medal gaming machines such as a slot machine, a roulette game machine, a card game machine and the like, in which medals are used as game media. Therefore, in the first and second embodiments, it will be explained the medal acceptance device 2 arranged in the roulette game machine 1, as the embodiment. The roulette game machine 1 is a gaming machine in which the player predicts a number and the like determined in a roulette wheel and bets the game media such as medals to the predicted number and the like, further when the number and the like betted is won, the player can get a predetermined number of medals as a payout.

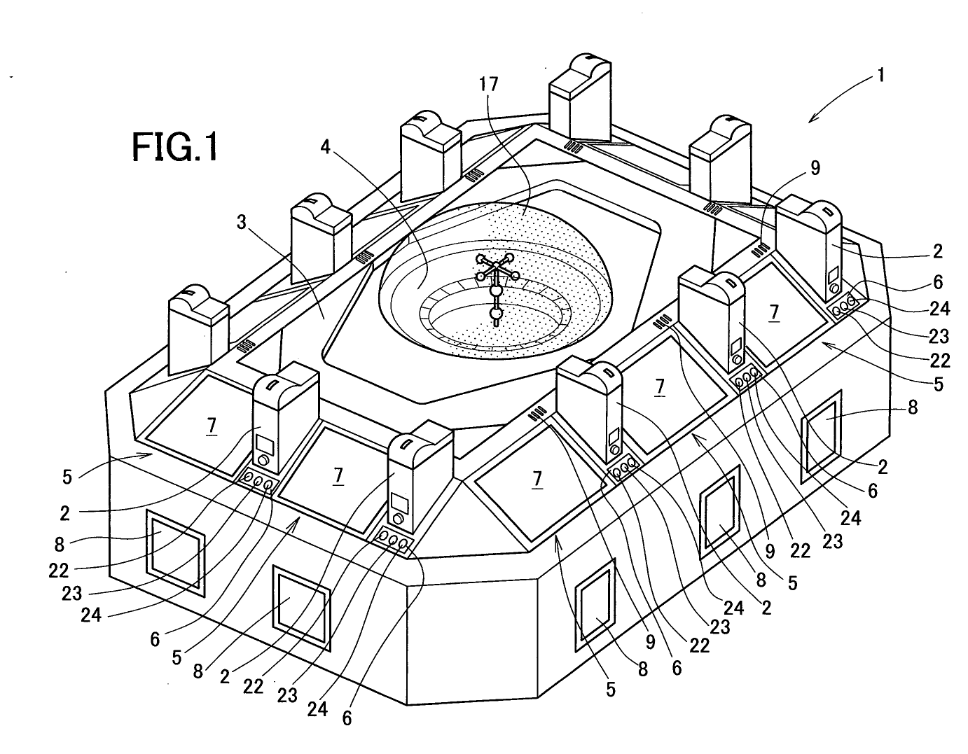

At first, the outline construction of the roulette game machine 1 according to the first embodiment will be described with reference to FIG. 1. FIG. 1 is an outline perspective view showing the outline construction of the roulette game machine according to the embodiment.

As shown in FIG. 1, the roulette game machine 1 is basically constructed from a cabinet 3 constructing a main body of the roulette game machine 1, a roulette wheel 4 arranged at a substantial center position on an upper surface of the cabinet 3 and a plurality of satellites 5 (in the embodiment, ten satellites 5) arranged around the roulette wheel 4 so as to enclose the roulette wheel 4.

Here, the satellite 5 is defined as a gaming space having at least the medal acceptance device 2 for inserting medals utilized in the roulette game, a control panel 6 on which a plurality of control buttons are arranged, the control buttons being used when the player inputs predetermined instructions and an image display device 7 for displaying images corresponding to the roulette game. And based on that the player operates the control panel 6 while seeing images displayed on the image display device 7, the roulette game can be progressed.

Further, at each of side surfaces of the cabinet 3 where the satellites 5 is arranged, a medal payout opening 8 is formed. And a speaker 9 for outputting music or effect sounds is provided at a right upper position of the image display device 7 in the satellite 5.

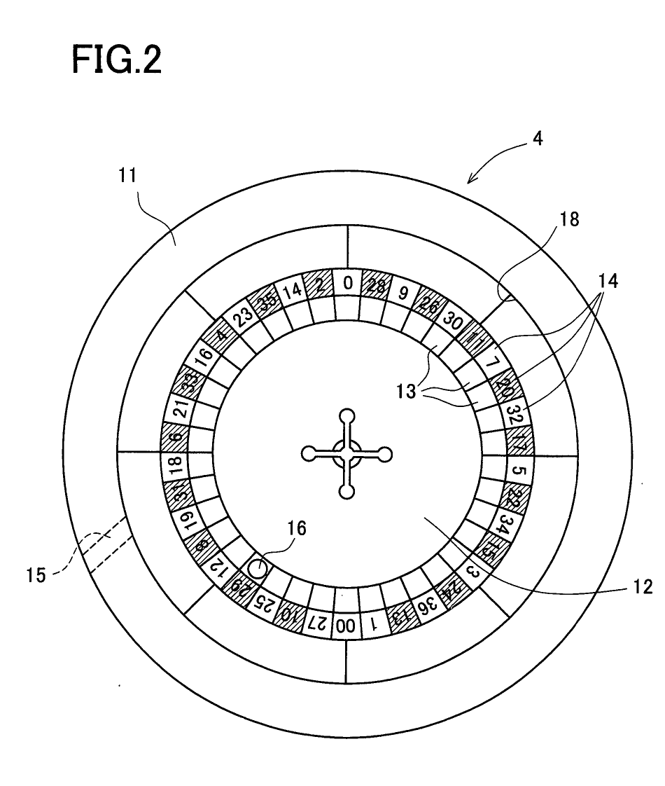

Next, the construction of the roulette wheel 4 according to the first embodiment will be described with reference to FIG. 2. FIG. 2 is a plan view of the roulette wheel according to the embodiment.

As shown in FIG. 2, the roulette wheel 4 is basically constructed from a frame 11 fixed on the cabinet 3 and a rotation wheel 12 which is rotatably received and supported within the frame 11. And on the upper surface of the rotation wheel 12 many pockets 13 (in the first embodiment, 38 pockets 13) each of which has a concave shape are formed. Further, on the upper surface of outer periphery of the pockets 13 formed on the rotation wheel 12, there are formed number display plates 14 on each of which one number among numbers “0”, “00”, “1”˜“36” is indicated so as to correspond to each pocket 13.

And a ball throw opening 15 is formed in the frame 11. To the ball throw opening 15 a ball throw device (not shown) is connected and a ball 16 is thrown on the rotation wheel 12 through the ball throw opening 15 according to drive of the ball throw device. Further, whole upper space over the roulette wheel 14 is covered by a cover member 17 with a dome shape which is formed of a transparent acrylic resin.

Here, the frame 11 is gradually inclined toward an inner side thereof and a guide wall 18 is formed at a middle portion of the frame 11. The guide wall 18 functions to guide the ball 16 thrown on the rotation wheel 12 against centrifugal force acting to the ball 16 and to roll and move the ball 16 therealong. And when rolling speed of the ball 16 becomes weak and the centrifugal force thereof disappears, the ball 16 rolls on the inclined surface of the frame 11 and drops toward the rotation wheel 12, thereby the ball 16 reaches to the rotation wheel 12 which is rotating.

Further, the ball 16 rolling toward the rotation wheel 12 passes through on the number display plates 14 arranged at the outer periphery of the rotation wheel 12 which is rotating and is received in any one of the pockets 13. At that time, the number described on the number display plate 14 corresponding to the pocket 13, on which the ball 16 is received, becomes a winning number.

And under the roulette wheel 4 a winning determination device (not shown) is arranged. The winning determination device is a device to determine the number attached to the pocket 13 on which the ball 16 is received. Further, under the rotation wheel 12 a ball collection device (not shown) is arranged. The ball collection device is a device to collect the ball 16 on the rotation wheel 12 after the game is terminated. Here, the ball throw device, the winning determination device and the ball collection device are already well-known, therefore explanation thereof will be omitted.

Next, the control panel 6 and the image display device 7 according to the first embodiment will be described.

The control panel 6 is, as shown in FIG. 1, provided at the side of the image display device 7 and buttons operated by the player are arranged on the control panel 6. Concretely, a BET confirmation button 22, a cashout button 23 and a help button 24 are arranged in an order from the left position when the player standing to face to the satellite 5 sees the satellite 5.

The BET confirmation button 22 is a button which is pressed when the player confirms the BET after bet operation (mentioned later) is done by using the image display device 7. And in a case that the BET is confirmed and the player bets to the number described on the number display plate 14 corresponding to the pocket 13 where the ball 16 is received while gaming, the game is won. If the game is won, the credit corresponding to the number of chips which are betted is added to the credit that the player retains at that time. Here, the BET operation will be described later in detail.

The cashout button 23 is a button which is usually pressed when the game is terminated, and when the cashout button 23 is pressed, medals (usually one credit corresponds to one medal) corresponding to the credit, which is obtained in the game and is retained by the player at that time, are paid out from the medal payout opening 8.

The help button 24 is a button which is pressed when the player cannot understand the game operation method, and when the help button 24 is pressed, a help image indicating various operation information is displayed on the image display device 7 right after press of the help button 24.

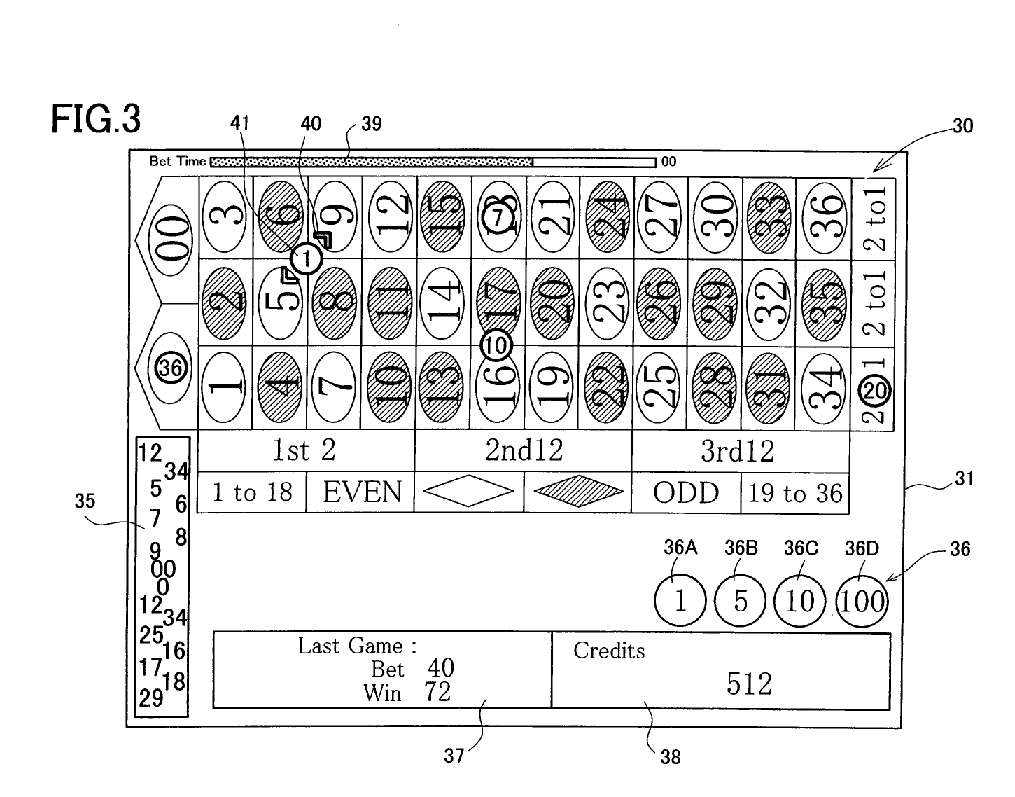

On the other hand, the image display device 7 is a liquid crystal display on a front plane of which a touch panel 28 is attached, and based on that an icon displayed on the liquid crystal display is touched by a finger and the like, such icon can be selected. FIG. 3 is an explanatory view showing one example of the display image displayed on the image display device 7.

As shown in FIG. 3, a BET image plane 31 having a betting board 30 of table type is displayed on the image display device 7 while the roulette game is done in the roulette game machine 1. And the player operates the BET image plane 31, thereby the player can bet chips by using the credit retained by the player.

Hereinafter, the BET image plane 31 will be described with reference to FIG. 3. On the betting board 30 of table type displayed on the BET image plane 31, the same numbers as “0”, “00”, “1”˜“36” displayed on the number display plates 14 are aligned and displayed in a grid pattern. And specific BET areas for betting chips by directing areas of “odd number”, “even number”, “kind of color of the number display plate (red or black)” “a predetermined number range (for example, “1”˜“12” and the like)” are also aligned and displayed in a grid pattern.

And at a lower position in the betting board 30 of table type, a result history display portion 35, unit BET buttons 36, a payout result display portion 37 and a credit display portion 38 are displayed in the order from the left side of the betting board 30.

In the result history display portion 35, results of winning numbers are displayed with a table in games previously done (here, one game means a series of operation during which the player bets in each satellite 5 and the ball 16 drops in the pocket 13 and the credit is paid out based on the winning number). At that time, after one game is terminated, a new winning number is added and displayed from the upper position, and the history of winning numbers during sixteen games to the maximum can be confirmed.

Further, the unit BET buttons 36 are buttons to bet on BET areas (on the grid of the number and the mark or on the line forming the grid) directed by the player. The unit BET buttons 36 comprise four kinds of buttons such as a 1 BET button 36A, a 5 BET button 36B, a 10 BET button 36C and a 100 BET button 36D.

At first, the player directly presses the BET area to be betted by the finger, thereby the player directs the BET area by a cursor 40 mentioned later. In this state, by pressing the 1 BET button 36A, the player can bet one chip every one time press (the BET number increases in the order of “1”→“2”→“3”→ . . . every the player presses the 1 BET button 36A by the finger). On the other hand, by pressing the 10 BET button 36C, the player can bet chips with the unit of ten (the BET number increases in the order of “10”→“20”→“30”→ . . . every the player presses the 10 BET button 36C). Here, operation of the 5 BET button 36B and the 100 BET button 36D is similarly done to the above. Therefore, even if many chips are betted, such operation can be simplified.

And in the payout result display portion 37 the BET number of chips by the player in the previous game and the payout credit number are displayed. Here, the number obtained by subtracting the BET number from the payout credit number represents the credit number newly obtained by the player in the previous game.

Further, in the credit number display portion 38, the credit number retained by the player at that time is displayed. This credit number decreases corresponding to the BET number (one credit for one chip) when chips are betted. And in a case that the betted number is won and the credit is paid out, the credit number increases corresponding to the payout number. Here, when the credit number retained by the player becomes “0”, the game is terminated.

And at an upper position of the betting board 30 of table type, a BET timer graph 39 is provided. The BET timer graph 39 indicates a graph representing a remaining time during which the player can bet and a red graph starts to extend in the right direction from the time that the game is started. And when the red graph extends to the most right position, the time that the player can bet in the present game is terminated. Further, in a case that the BET timer graph 39 reaches to a predetermined position (for example, the position that the red graph extends to ⅔ of the BET timer graph 39), the ball 16 is thrown in the roulette wheel 4 from the ball throw device arranged in the roulette wheel 4.

And on the betting board 30 of table type, a cursor 40 indicating the BET area selected by the player is displayed. And a chip mark 41 indicating the chip number betted up to the present time and the BET area is displayed. The number displayed on the chip mark 41 indicates the BET number of chips. For example, as shown in FIG. 3, the chip mark 41 of “7” put on the grid of “18” indicates that seven chips are betted to the number “18”. As mentioned, the method to bet only to one number is a BET method called as “straight up”.

And the chip mark 41 of “1” put on an intersection of the grids of “5”, “6”, “8”, “9” indicates that one chip is betted so as to cover four numbers of “5”, “6”, “8”, “9”. Here, as mentioned, the method to bet while covering four numbers is a BET method called as “corner BET”.

As for the other BET methods, there are several BET methods such as “sprit BET” to bet on the line between two numbers so as to cover two numbers, “street BET” to bet to an end of a horizontal line of numbers (vertical line in FIG. 3) so as to cover three numbers (for example, “13”, “14”, “15”), “five BET” to bet on the line between “00” and “3” so as to cover five numbers of “0”, “00”, “1”, “2”, “3”, “line BET” to bet between the numbers in two horizontal lines (vertical lines in FIG. 3) so as to cover six numbers (for example, “13”, “14”, “15”, “16”, “17”, “18”), “column BET” to bet on the grid described as “2 to 1” so as to cover twelve numbers, and “dozen BET” to bet on the grid described as “1st 12”, “2nd 12”, “3rd 12” so as to cover twelve numbers. Further, there are BET methods to bet while covering eighteen numbers, according to whether the color of the number display plate 14 is red or black, whether the number is odd or even and whether the number is smaller than 18 or is lager than 19, by utilizing six grids provided at the lowest position in the betting board 30 of table type.

When the player bets on the BET image plane 31 constructed according to the above, the player first directs the BET area (on the grid of the number and the mark or on the line forming the grid) to be betted on the image plane and directly presses by the finger. As a result, the cursor 40 moves to the BET area which is directed.

Thereafter, by pressing each unit BET button (1 BET button 36A, 5 BET button 36B, 10 BET button 36C, 100 BET button 36D) of the unit BET buttons 36, medals corresponding to the unit number are betted to the BET area which is directed. For example, in a case that the 10 BET button 36C is pressed in four times, the 5 BET button 36B is pressed in one time and the 1 BET button 36A is pressed in three times, forty eight (48) medals can be totally betted.

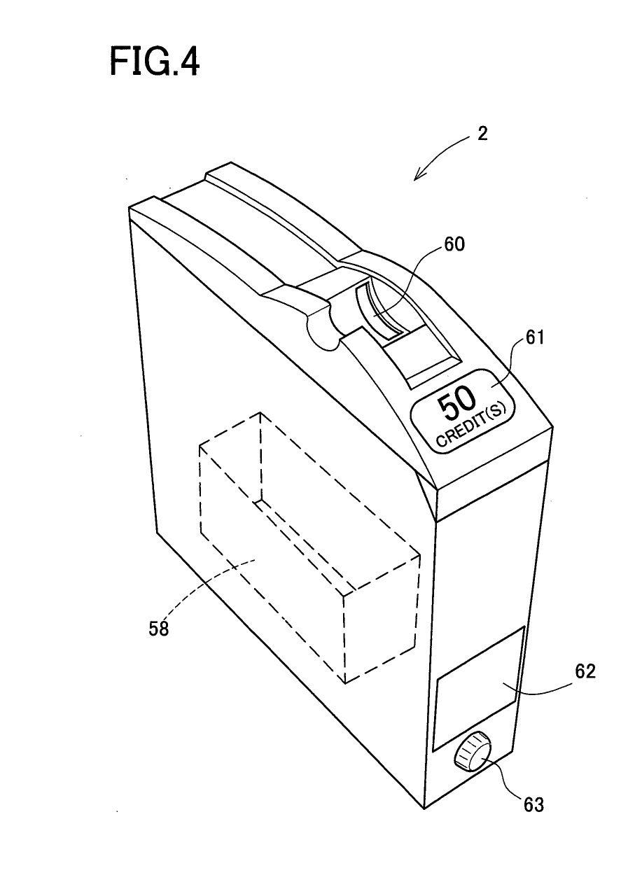

Next, the medal acceptance device according to the first embodiment will be described with reference to FIG. 4. FIG. 4 is a perspective view sowing the medal acceptance device of the first embodiment.

As shown in FIG. 4, the medal acceptance device has a substantial parallelepiped shape and is a device in which an IC medal with an electronic tag therein is inserted and the IC medal is accepted. Here, the IC medal includes a game IC medal 65 which the player uses when a game is conducted and a value setting IC medal 66 for changing a value of the game IC medal 65 (credit number added per one game IC medal 65). Detail explanation of the game IC medal 65 and the value setting IC medal 66 will be done hereinafter.

In the medal acceptance device 2, there are provided a medal insertion slot 60 in which medals are inserted, a medal value display portion 61 for displaying the value of the game IC medal 65 (credit number added per one game IC medal 65) at present, a medal return opening 62 to which medals are returned and a key insertion opening 63 utilized when the inner portion of the medal acceptance device 2 is opened and closed.

Here, the medal insertion slot 60 is an insertion slot in which the game IC medal 65 is inserted when the player increases the credit number used in the game. Every the player inserts one game IC medal 65 inserts, the credit number retained by the player increases corresponding to the credit number displayed in the medal value display portion 61. Here, the credit number retained by the player is displayed in the credit number display portion 38 of the BET image plane 31.

The medal value display portion 61 is formed from 7-segment LEDS and displays the value per one game IC medal 65 at present by using the credit number. That is to say, when the game IC medal 65 is inserted through the medal insertion slot 60 while the number “50” is displayed, 50 credits per one game IC medal 65 are added to the credit number retained by the player. Similarly, when the game IC medal 65 is inserted while the number “100” is displayed, 100 credits per one game IC medal 65 are added to the credit number retained by the player. And the value of one game IC medal 65 can be changed for a predetermined time by the value setting IC medal 66 mentioned later. Here, a predetermined time corresponds to an inserted number of the game IC medal 65 and when the inserted number of the game IC medal 65 reaches to the number set by a restoration number setting switch 64 (mentioned later), the value of the game IC medal 65 changed by the value setting IC medal 66 is restored to the previous value before changed. And the medal value display portion 61 is not limited to the 7-segment LEDs, and for example, the medal value display portion 61 may be constructed from a liquid crystal display device. And change procedure of the value of the game IC medal 65 and restoration procedure thereof will be described hereinafter.

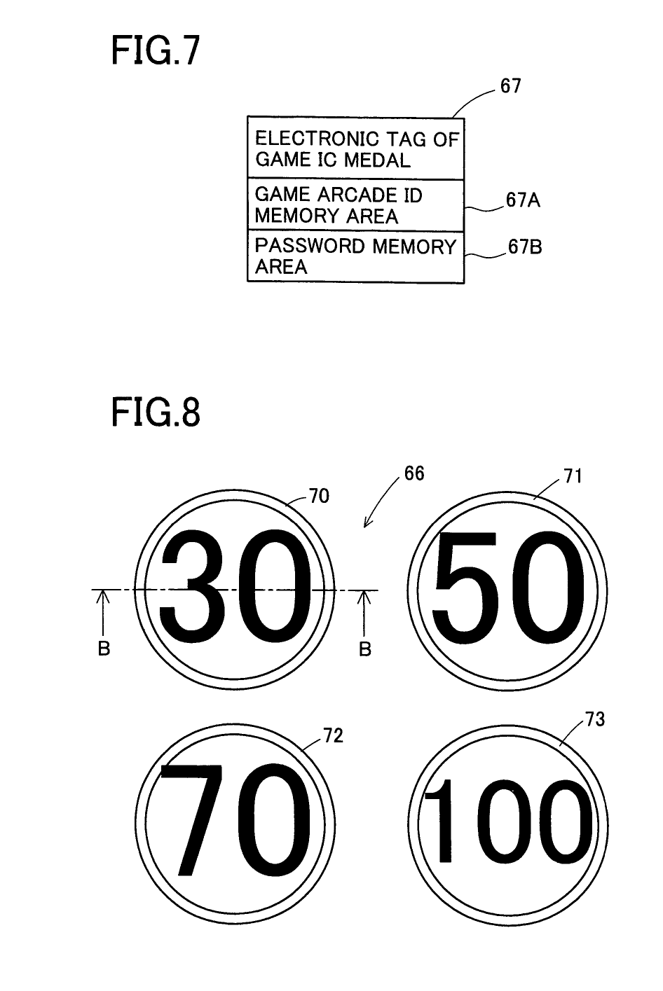

If the medal inserted in the medal insertion slot 60 is not a proper IC medal, such improper IC medal is returned to the medal return opening 62. As a case that the inserted IC medal is not a proper IC medal, it will be conceivable cases that the inserted medal is a usual medal in which the electronic tag is not included, the inserted medal is a IC medal which is bought or borrowed in the other game arcade and the inserted medal is a forged medal. And determination whether or not the inserted medal is a proper medal is conducted by reading out a game arcade ID and a password (see FIGS. 7 and 10).

The key insertion opening 63 is the insertion opening in which a key (not shown) to open and close a door (not shown) provided with the medal acceptance device 2 is inserted. If the predetermined key is inserted in the key insertion opening 63 and is rotated in a predetermined direction, a lock state of a lock device (not shown) is released, thereby the door is opened. In the medal acceptance device 2, a restoration number setting switch 64 is provided through which it can be set the inserted number of the game IC medal 65 till the value of the game IC medal 65 changed by the value setting IC medal 66 is restored to a default value (in the first embodiment, 50 credits per one game IC medal 65) before changed.

And it is formed a medal reception portion 58 in which the inserted medals are received. Further, the medals in the medal reception portion 58 can be collected by opening the door. And maintenance of the inner portion in the medal acceptance device 2 can be done.

Next, construction of the IC medals according to the embodiment will be described with reference to FIGS. 5 to 10. Here, the IC medals of the embodiment are basically classified into two kinds of the game IC medal 65 and the value setting IC medal 66. The game IC medal 65 is a medal bought or borrowed by predetermined money (for example, 500 yen) from a specific IC medal lending machine (not shown) installed in the game arcade when the player starts the game. And the credit number retained by the player can be increased and the game can be started by inserting the game IC medal 65 in the medal insertion slot 60. On the other hand, the value setting IC medal is a specific medal which is retained only by the game arcade and the value of the game IC medal 65 (credit number added per one game IC medal) set at present can be changed by inserting the value setting IC medal 66 in the medal insertion slot 60.

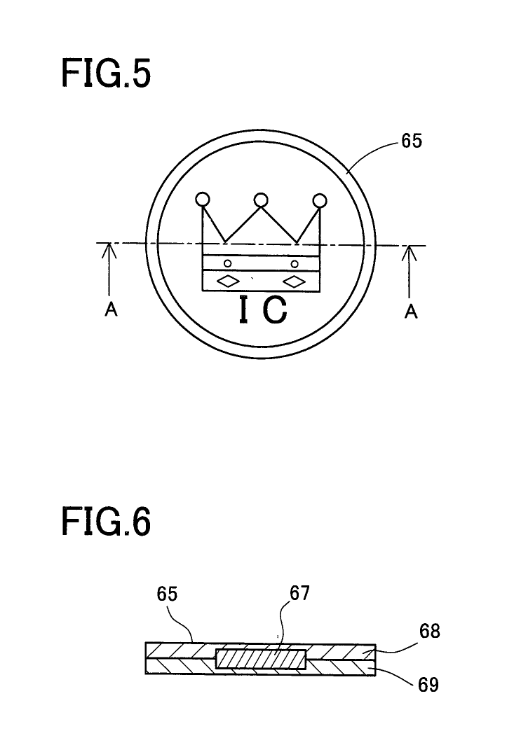

At first, the game IC medal 65 will be described hereafter. FIG. 5 is a plan view showing an outline of the game IC medal according to the embodiment. And FIG. 6 is a sectional view of the game IC medal when sectioned along the A-A line in FIG. 5.

As shown in FIGS. 5 and 6, the game IC medal 65 is formed into a thin circular shape and it is formed on a surface of the game IC medal 65 a pattern designed every game arcade where such medal is used. On the other hand, as for the inner construction, a non-contact type electronic tag 67 is embedded in the game IC medal 65. And two base members 68 and 69, which are made of resin or alloy, are superimposed and fixed with each other so as to enclose the electronic tag 67.

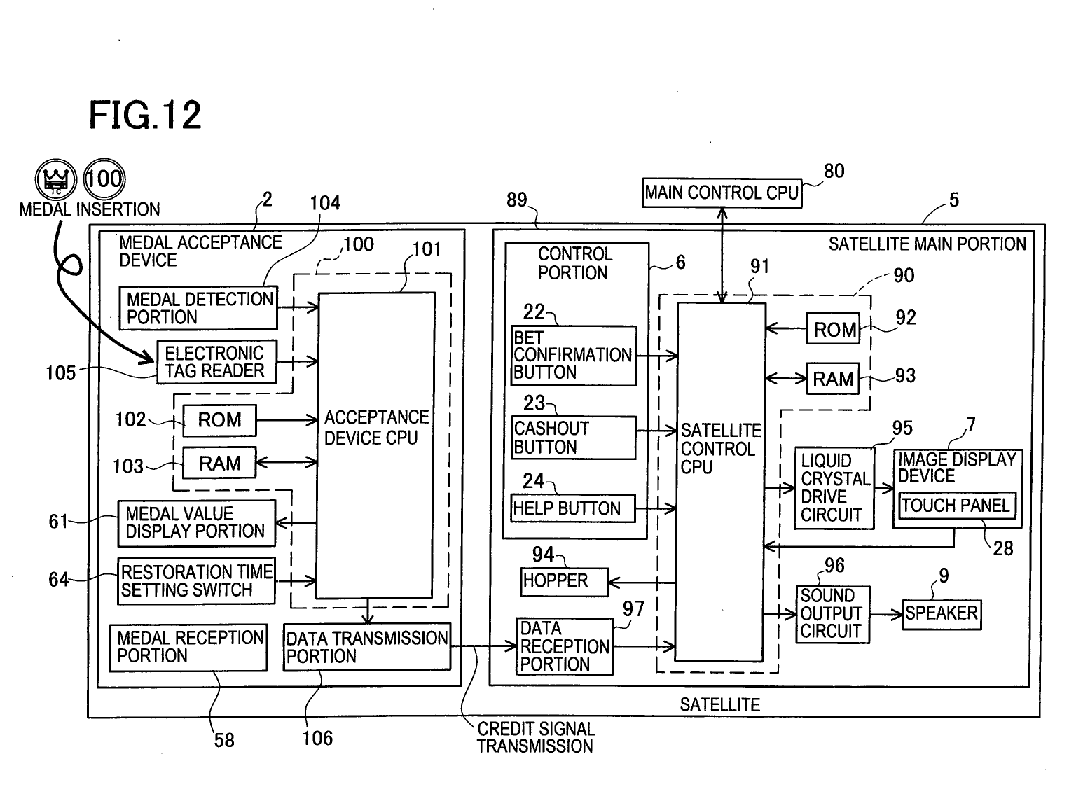

Here, the electronic tag 67 is basically constructed from an IC chip in which various information is recorded and an antenna coil electrically connected to the IC chip. The electronic tag 67 is a non-contact type electronic tag and can transmit the information to an electronic tag reader 105 (see FIG. 12) provided in the medal acceptance device 2. Concretely, line of magnetic force is produced from a coil (not shown) arranged in the electronic tag reader 105 and when the antenna coil of the electronic tag 67 embedded in the game IC medal 65 inserted through the medal insertion slot 60 passes through the line of magnetic force, inductive electromotive force is produced. And such inductive electromotive force is supplied to the IC chip as electric power, thereby the electronic tag 67 can transmit data recorded in the IC chip to the electronic tag reader 105.

Further, as shown in FIG. 7, the electronic tag 67 has a game arcade ID memory area 67A in which the game arcade ID is stored and a password memory area 67B in which the password is stored. The game arcade ID is an ID which is determined every game arcade which issues the game IC medal 65 and the password comprises a character line which is independently added to confirm whether or not the game IC medal 65 is true. Therefore, the game arcade ID and the password of the game IC medal 65 inserted are read out by the electronic tag reader 105 and such game arcade ID and the password read out are verified with the proper game arcade ID and the password stored in a ROM 102 (mentioned later), thereby it can be determined whether or not the medal inserted is the proper game IC medal 65.

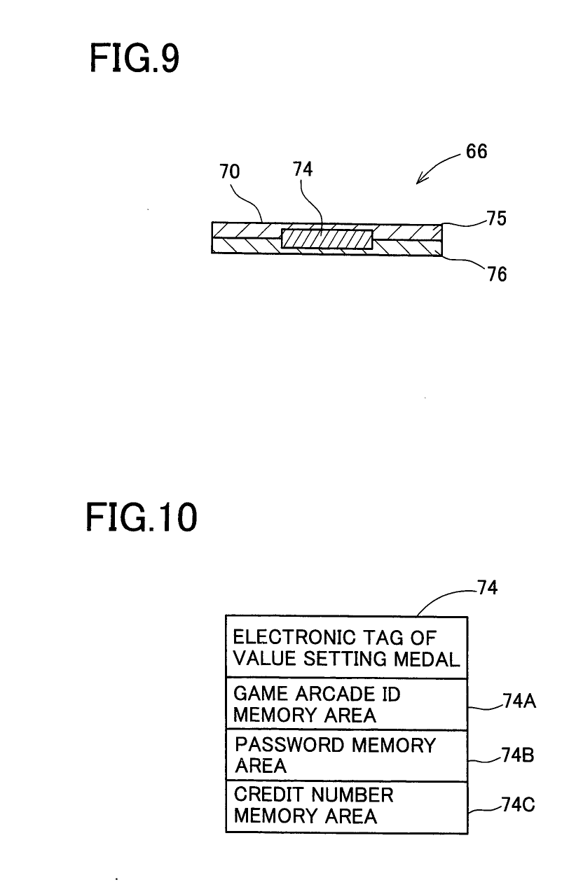

Next, the value setting IC medal 66 will be described. FIG. 8 is a plan view showing an outline of the value setting IC medal according to the embodiment. FIG. 9 is a sectional view of the value setting IC medal when sectioned along the B-B line in FIG. 8.

As shown in FIG. 8, the value setting IC medal 66 comprises four kinds of medals in total. Although, as mentioned, the value setting IC medal 66 can change the value of the game IC medal (credit number added per one game IC medal) at present by inserting in the medal insertion slot 60, each of four kinds of medals is constructed so as to have different value, respectively.

Concretely, there exist four kinds of a 30 credit setting IC medal 70 for setting so as to add 30 credits to the credit number retained by the player every one game IC medal is inserted, a 50 credit setting IC medal 71 for setting so as to add 50 credits to the credit number retained by the player every one game IC medal is inserted, a 70 credit setting IC medal 72 for setting so as to add 70 credits to the credit number retained by the player every one game IC medal is inserted and a 100 credit IC setting medal 73 for setting so as to add 100 credits to the credit number retained by the player every one game IC medal is inserted.

And on a surface of each medal one of the numbers “30”, “50”, “70” and “100” is respectively provided so that the credit number to be set can be easily determined.

Further, as shown in FIGS. 8 and 9, each of the 30 credit setting IC medal 70, the 50 credit setting IC medal 71, the 70 credit setting IC medal 72 and the 100 credit setting IC medal 73 is formed into a thin circular shape and it is formed on a surface of each credit setting IC medal the number indicating the credit number. On the other hand, as for the inner construction, a non-contact type electronic tag 74 is embedded in each credit setting IC medal. And two base members 75 and 76, which are made of resin or alloy, are superimposed and fixed with each other so as to enclose the electronic tag 74. Here, although only the sectional view of the 30 credit setting IC medal 70 is shown in FIG. 9, each of the 50 credit setting IC medal 71, the 70 credit setting IC medal 72 and the 100 credit setting IC medal 73 has the same sectional shape as that of the 30 credit setting IC medal 70. Thus, it will be explained the 30 credit setting IC medal 30 as an example hereinafter, and explanation of the 50 credit setting IC medal 71, the 70 credit setting IC medal 72 and the 100 credit setting IC medal 73 will be omitted.

Here, the electronic tag 74 is basically constructed from an IC chip in which various information is recorded and an antenna coil electrically connected to the IC chip. The electronic tag 74 is a non-contact type electronic tag and can transmit the information to an electronic tag reader 105 (see FIG. 12) provided in the medal acceptance device 2. Concretely, line of magnetic force is produced from a coil (not shown) arranged in the electronic tag reader 105 and when the antenna coil of the electronic tag 74 embedded in the value setting IC medal 66 inserted through the medal insertion slot 60 passes through the line of magnetic force, inductive electromotive force is produced. And such inductive electromotive force is supplied to the IC chip as electronic power, thereby the electronic tag 74 can transmit data recorded in the IC chip to the electronic tag reader 105.

Further, as shown in FIG. 10, the electronic tag 74 has a game arcade ID memory area 74A in which the game arcade ID is stored, a password memory area 74B in which the password is stored and a credit number memory area 74C in which the credit number set as the value of the game IC medal is stored. The game arcade ID is an ID which is determined every game arcade which issues the value setting IC medal 66 and the password comprises a character line which is independently added to confirm whether or not the value setting IC medal 66 is true. Therefore, the game arcade ID and the password of the value setting IC medal 66 inserted are read out by the electronic tag reader 105 and such game arcade ID and the password read out are verified with the proper game arcade ID and the password stored in a ROM 102 (mentioned later), thereby it can be determined whether or not the medal inserted is the proper value setting IC medal 66.

And the credit number stored in the credit number memory area 74C is the credit number when the value per one game IC medal 65 is set. That is to say, the number “30” is stored in the 30 credit setting IC medal 70. And the number “50” is stored in the 50 credit setting IC medal 71. Further, the number “70” is stored in the 70 credit setting IC medal 72. And the number “100” is stored in the 100 credit setting IC medal 73. And the credit number of the value setting IC medal 66 inserted is read out by the electronic tag reader 105 and the credit number read out is stored in a RAM 103 (see FIG. 14). Continuously, the medal acceptance device 2 changes display of the medal value display portion 61 to the changed credit number and conducts acceptance of the game IC medal 65 based on the changed credit number. And if the game IC medal 65 is inserted so that the inserted number thereof reaches to the number set by the restoration number setting switch 64, the value of the game IC medal 65 is restored to the credit number (in the first embodiment, 50 credits) corresponding to the default value before changed.

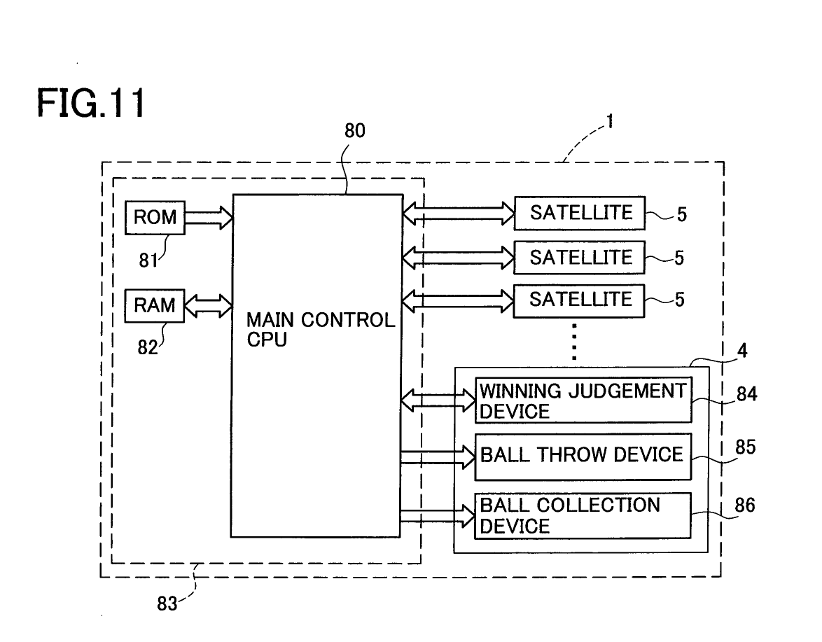

Next, control system of the roulette game machine 1 will be described with reference to FIG. 11. FIG. 11 is a block diagram schematically showing a control system of a roulette game machine according to the embodiment.

As shown in FIG. 11, the roulette game machine 1 is basically constructed from a main control portion 83 including a main control CPU 80, a ROM 81 and a RAM 82, a roulette wheel 4 connected to the main control portion 83 and ten satellites 5 (see FIG. 1). Here, a control system of the satellite 5 will be described hereinafter.

The main control CPU 80 executes various processes based on input signals supplied from each of the satellites 5 and data and programs stored in the ROM 81 and the RAM 82, and transmits command signals to the satellite 5 based on the result, thereby the main control CPU 80 mainly controls each of the satellites 5 and progresses the game. Further, the main control CPU 80 controls a winning determination device 84 arranged in the roulette wheel 4, a ball throw device 85 and a ball collection device 86, thereby the main control CPU 80 conducts throw of the ball 16 in the roulette wheel 4, collection of the ball 16 from the roulette wheel 4 and determination of the winning number of the pocket 13 in which the ball 16 drops.

The ROM 81 is, for example, constructed from a semi-conductor memory and the like, and programs for executing basic function of the roulette game machine 1 and programs for controlling each device in the roulette wheel 4 and programs for mainly controlling each satellite 5 are stored in the ROM 81.

On the other hand, the RAM 82 temporarily stores bet information of chip supplied from each satellite 5, the winning number data determined by the winning determination device 84 and data concerning with the result of processes executed by the main control CPU 80.

And to the main control CPU 80, the winning determination device 84 arranged in the roulette wheel 4, the ball throw device 85 and the ball collection device 86 are connected. And in each satellite 5, in a case that a time for betting by the player is elapsed for a predetermined time, that is, the BET timer graph 39 on the BET image plane 31 reaches to a specific position (for example, the position corresponding to ⅔ of the Bet timer graph 39), the main control CPU 80 drives the ball throw device 85, thereby the ball 16 is thrown in the roulette wheel 4.

Further, when rolling speed of the ball 16 gradually becomes weak and the centrifugal force thereof disappears, the ball 16 rolls on the inclined surface of the frame 11 and drops toward the rotation wheel 12, thereby the ball 16 is received in the pocket 13. Thereafter, the winning determination device 84 determines the number described on the number display plate 14 corresponding to the pocket 13 in which the ball 16 is received. Such determination result is transmitted to the main control CPU 80. Further, the ball collection device 86 is driven and the ball 16 is collected from the roulette wheel 4.

Next, construction of the control system of the satellite 5 connected to the CPU 80 in the main control portion 83 will be described with reference to FIG. 12. FIG. 12 is a block diagram schematically showing a control system of a satellite according to the first embodiment. Here, each of the satellites 5 basically has the same construction, thus the construction of the satellite 5 will be described while raising one satellite 5 as an example.

As shown in FIG. 12, the satellite 5 is basically constructed from a main portion 89 in which the image display device 7 and the other devices are provided and the medal acceptance device 2 attached to the main portion 89. Further, the main portion 89 is constructed from a satellite control portion 90 and some periphery devices. The satellite control portion 90 comprises a satellite control CPU 91, a ROM 92 and a RAM 93. The ROM 92 is, for example, constructed from a semi-conductor device and stores programs for realizing basic function of the satellite 5, various programs necessary for control of the satellite 5 and data tables. And the RAM 93 temporarily stores various data calculated by the satellite control CPU 91, the credit number retained by the player at present and bet state of chip by the player.

And to the satellite CPU 91, the BET confirmation button 22 provided in the control panel 6 (see FIG. 1), the payout button 23 and the help button 24 are respectively connected. Further, the satellite control CPU 91 conducts control to execute various operations based on operation signals output according to press of each button. Concretely, the satellite control CPU 91 executes various processes based on the input signals supplied from the control panel 6 corresponding to input operation by the player and data and programs stored in the ROM 92 and the RAM 93. The satellite control CPU 91 transmits the result to the main control CPU 80 of the above mentioned main control portion 90.

Contrarily, the satellite control CPU 91 receives command signals from the main control CPU 80 and controls the periphery devices constructing the satellite 5 and progresses the roulette game at the satellite 5. Further, corresponding to contents of the process, the satellite control CPU 91 executes various processes based on input signals supplied from the control panel 6 according to input operation by the player and data and programs stored in the ROM 92 and the RAM 93. On the basis of the result, the satellite control CPU 91 controls the periphery devices constructing the satellite 5 and progresses the roulette game at the satellite 5. Here, concerning with that processes are conducted by which method, such method is set every process corresponding to contents of the process. For example, the medal payout process corresponding to the winning number is done by the former method and the bet operation process by the player on the BET image plane 31 is done by the latter method.

And to the satellite control CPU 91, a hopper 94 is connected. The hopper 94 pays out a predetermined number of medals from the medal payout opening 8 (see FIG. 1) corresponding to the command signal from the satellite control CPU 91.

Further, to the satellite control CPU 91, the image display device 7 is connected through a liquid crystal drive circuit 95. Here, the liquid crystal control circuit 85 is constructed from a program ROM, an image ROM, an image control CPU, a work RAM, a VDP (Video Display Processor) and a video RAM. And image control program concerning with display in the image display device 7 and various selection tables are stored in the program ROM. Further, in the image ROM, for example, dot data for forming images displayed on the image display device 7 are stored. The image control CPU determines the image displayed on the image display device 7 among the dot data stored beforehand in the image ROM based on parameters set by the satellite control CPU 91 according to the image control program stored in the program ROM. And the work RAM is used as a temporary memory when the image control program is executed by the image control CPU. Further, the VDP forms the image corresponding to display contents determined by the image control CPU and outputs the image to the image display device 7. Here, the video RAM is used as a temporary memory when the image is formed by the VDP.

Further, as mentioned, in front of the image display device 7, the touch panel 28 is attached and operation information of the touch panel 28 is transmitted to the satellite control CPU 91. On the touch panel 28 it is conducted bet operation of chip by the player on the BET image plane 31. Concretely, operation of the touch pane 28 is done in selection of the BET area and operation of the unit BET buttons 36, and such operation information is transmitted to the satellite control CPU 91. And various processes such as change operation of images are done based on the operation information.

Further, a sound output circuit 96 and a speaker 9 are connected to the satellite control CPU 91 and the speaker 9 produces various effect sounds when various effects are done based on output signals from the sound output circuit 96.

And to the satellite control CPU 91 a data reception portion 97 is connected and the data reception portion 97 receives a credit signal transmitted from the medal acceptance device 2. The credit signal is information concerning with the credit number added based on the value data (credit number added per one game IC medal 65) of the game IC medal 65 at present, the information being obtained by the medal acceptance device 2, when the game IC medal 65 is inserted in the medal acceptance device 2, as mentioned. The satellite control CPU 91 increases the credit number retained by the player stored in the RAM 93, based on the credit signal transmitted.

Next, the medal acceptance device 2 attached to the main portion 89 will be described. The medal acceptance device 2 is constructed from an acceptance device control portion 100 and some periphery devices. Further, the acceptance device control portion 100 is constructed from a CPU 101 for acceptance device, a ROM 102 and a RAM 103. The acceptance device CPU 101 conducts various processes based on data and programs stored in the ROM 102 and the RAM 103, and transmits the credit signal (mentioned later) to the satellite 5 on the basis of the result.

The ROM 102 is, for example, constructed from a semi-conductor memory and programs for realizing basic function of the medal acceptance device 2, the game arcade ID and the password of the game IC medal 65 and the value setting IC medal 66 and the other various programs necessary for control of the medal acceptance device 2 are stored in the ROM 102. And the RAM 103 is a memory for temporarily storing various data calculated by the acceptance device CPU 101 and the value data (the credit number added per one game IC medal) of the game IC medal 65, the inserted medal number till the value data are restored, the counter counting the inserted medal number up to the present time since the value data are changed and the value data corresponding to the default.

Further, in the medal acceptance device 2, it is provided a medal reception portion 58 in which the game IC medal 65 and the value setting IC medal 66 are received.

And to the acceptance device CPU 101, a medal detection portion 104 is connected. The medal detection portion 104 detects medals inserted from the medal insertion slot 60 (see FIG. 4) and the acceptance device CPU 101 calculates medals inserted based on the medal detection signal output from the medal detection portion 104. And if the game IC medal 65 is detected, the game IC medal 65 is counted by a medal insertion number counter 103C in the RAM 103 mentioned later.

Further, to the acceptance device CPU 101, an electronic tag reader 105 is connected. The electronic tag reader 105 reads out the game arcade ID and the password recorded in the game arcade ID memory area 67A and the password memory area 67B (see FIG. 7) of the electronic tag 67 embedded in the game IC medal 65 which is inserted. And the electronic tag reader 105 also reads out the game arcade ID, the password and the credit number set corresponding to the value per one game IC medal 65 all of which are respectively recorded in the game arcade ID memory area 74A, the password memory area 74B and the credit number memory area 74C (see FIG. 10) of the electronic tag 74 embedded in the value setting IC medal 66.

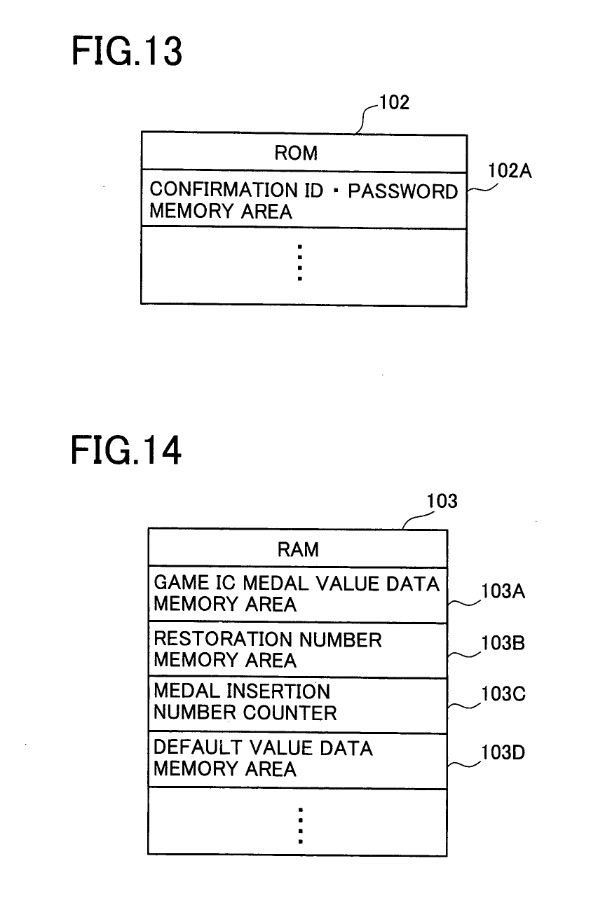

And each information read out is transmitted to the acceptance device CPU 101 and the acceptance device CPU 101 compares the game arcade ID and the password read out from the game IC medal 65 with the confirmation ID and the password stored in the confirmation and password memory area 102A of the ROM 102, and determines whether or not the game ID medal 65 or the value setting IC medal 66 is proper. Further, the acceptance device CPU 101 changes the value data of the game IC medal 65 at present stored in the value data memory area 103A (see FIG. 13) of the RAM 103.

And to the acceptance device CPU 101, a restoration number setting switch 64 is connected. Here, in the medal acceptance device of the first embodiment, when a predetermined number of the game IC medals 65 are detected by the medal detection portion 104, the value data of the game IC medal 65, the value data being changed by the value setting IC medal 66, are restored to the default value data which are the value data before changed and are stored in the default value data memory area 103D in the RAM 103. The restoration number setting switch 64 sets the predetermined number at that time.

Operation information of the restoration number setting switch 64 is transmitted to the acceptance device CPU 101 and the set number is stored in the restoration number memory area 103B in the RAM 103. On the other hand, if the game IC medal 65 is detected by the medal detection portion 104, the count value of the medal insertion counter 103C in the RAM 103 is read out and the value “1” is added to the count value.

Further, when the count value of the medal insertion number counter 103C reaches to the value of the medal number stored in the restoration number memory area 103B, the value data of the game IC medal 65 at present time stored in the value data memory area 103A for the game IC medal are restored to the default value data (in the first embodiment, 50 credits per one game IC medal) stored in the default value data memory area 103D.

Further, the medal value display portion 61 is connected to the acceptance device CPU 101. The medal value display portion 61 displays the credit number added per one game IC medal 65 based on the value data of the game IC medal at present stored in a medal value memory area 103A for the game IC medal in the RAM 103.

Further, a data transmission portion 106 is connected to the acceptance device CPU 101. The data transmission portion 106 transmits the credit signal to the main portion 89. As mentioned, the credit signal is information concerning with the additional credit obtained by the acceptance device CPU 101 based on the value data of the game IC medal 65 at present stored in the RAM 103 when the game IC medal 65 is inserted in the medal acceptance device 2. And the satellite control CPU 91 increases the credit number stored in the RAM 93 based on the credit signal which is transmitted.

And as shown in FIG. 13, in the ROM 102 it is formed a memory area 102A for confirmation ID and password in which it is stored a confirmation ID to confirm whether or not an inserted medal is a proper IC medal and has a password.

And as shown in FIG. 14, in the RAM 103 it is formed the value data memory area 103A for the game IC medal in which the value data indicating the value of the game IC medal 65 (credit number added per one game IC medal) at present are stored, the restoration number memory area 103B for storing the game IC medal insertion number till the changed value data are restored, the medal insertion number counter 103C for counting the insertion number of the game IC medal 65 at present and the default value data memory area 103D for storing the default value data to which the value data are restored.

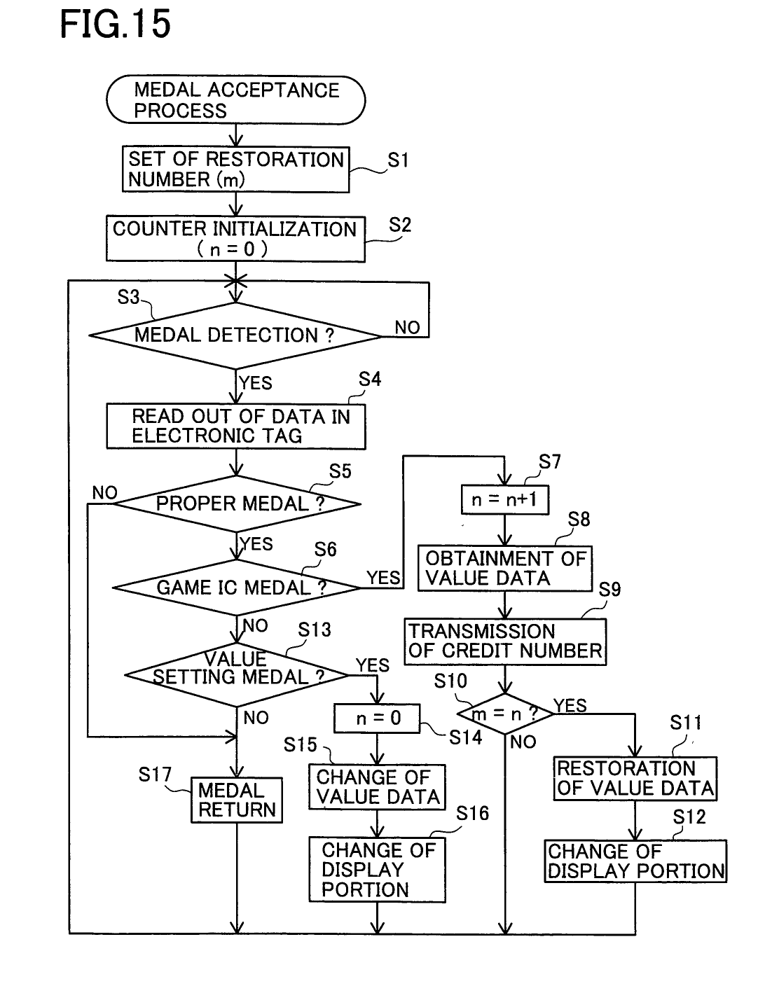

In addition to the above, a medal acceptance process conducted in the medal acceptance device 2 will be described with reference to FIG. 15. FIG. 15 is a flowchart of a medal acceptance process program. The program shown in FIG. 15 with a flowchart is stored in the ROM 102 or the RAM 103 provided with the medal acceptance device 2 and such program is executed by the acceptance device CPU 101.

Ar first, in step (abbreviated as “S” hereinafter) 2, the insertion number (here, it is supposed that the insertion number is “m”) of the game IC medal 65 till the value data changed by the value setting IC medal 66 are restored is set in the restoration number setting switch 64. The restoration number setting switch 64 is provided in the medal acceptance device 2 (see FIG. 4) and this switch is set by the game arcade.

And the insertion number of the game IC medal 65 which is set is stored in the restoration number memory area 103B (see FIG. 14).

Next, in S2, the medal insertion number counter 103C (see FIG. 14) is initialized. The medal insertion number counter 103C counts the number of the game IC medal 65 which is inserted. And as mentioned later, if the game IC medal 65 is detected in the medal detection portion 104, the count value of the medal insertion number counter 103C in the RAM 103 is read out, thereafter the number “1” is added to the count value, Thereafter, procedure shifts to S3.

In S3, it is determined whether or not the medal is detected by the medal detection portion 104. If the medal is not detected (S3: NO), procedure waits till the medal is detected. On the other hand, if the medal is detected (S3: YES), procedure shifts to S4.

In S4, various data stored in the electronic tags 67, 74 (see FIGS. 6 and 9) embedded in the IC medal are read out by the electronic tag reader 105. As the read out data, there are the game arcade ID, the password, the credit number (see FIGS. 7 and 10). Thereafter, procedure shifts to S5.

In S5, based on the data read out in S4, it is determined whether or not a medal inserted is the proper IC medal. This determination whether or not the inserted medal is the proper IC medal is conducted as follows. That is to say, the acceptance device CPU 101 verifies the game arcade ID and the password read out from the electronic tags 67, 74 with the confirmation game arcade ID and the password stored in the memory area 102A for confirmation ID and password of the ROM 102, and determines whether or not the inserted medal is the proper IC medal. And if it is determined that the inserted medal is the proper IC medal (S5: YES), procedure shifts to S6 and the IC medal inserted is collected in the medal reception portion 58. On the other hand, if it is determined that the inserted medal is not proper IC medal (S5: NO), procedure shifts to S17 and the medal is returned from the medal return opening 62.

Next, in S6, it is determined whether or not the medal inserted is the game IC medal 65. This determination whether or not the inserted medal is the game IC medal 65 is conducted based on the kind of the game arcade ID and the password read out from the electronic tags 67, 74 in S2. And if it is determined that the medal inserted is the game IC medal 65 (S6: YES), procedure shifts to S7. On the other hand, if it is determined that the medal is not the game IC medal 65 (S6: NO), procedure shifts to S13.

And in S7, the insertion number of the game IC medal 65 is counted. Concretely, the acceptance device CPU 101 reads out the count value of the medal insertion number memory area 103C in the RAM 103 and adds the number “1” to the count value. Thereafter, procedure shifts to S8.

And in S8, the acceptance device CPU 101 obtains the value data of the game IC medal 65 (credit number added per one game IC medal) at present, the value data being stored in the medal value memory area 103A for the game IC medal in the RAM 103.

Next, in S9, based on the value data of the game IC medal obtained in S5, the credit number which is added as the credit retained by the player is transmitted to the satellite main portion 89 through the data transmission portion 106. And the satellite control CPU 91 increases the credit number of the player stored in the RAM 93 based on the transmitted credit number.

Thereafter, in S10, it is determined whether or not the insertion number of the game IC medal 65 reaches to the predetermined insertion number. Concretely, the count value of the medal insertion number counter 103C in the RAM 103 is read out and it is determined whether or not the count value is as same as the restoration number stored in the restoration number memory area 103B by comparing the count value with the restoration number.

And if the insertion number of the game IC medal 65 does not reach to the predetermined insertion number (S10: NO), procedure returns to S1 and the above processes are repeated. On the other hand, if the insertion number of the game IC medal 65 reaches to the predetermined number (S10: YES), procedure shifts to S11.

In S11, the value data at present stored in the medal value data memory area 103A for the game IC medal are changed to the default value data (in the first embodiment, 50 credits per one game IC medal 65) which are stored in the default value data memory area 103D.

Next, in S12, based on the credit number (50 credits) of the default restored in S11, display in the medal value display portion 61 is changed. Thereafter, procedure returns to S1 and the above processes are repeated.

On the other hand, if it is determined that the medal is not the game IC medal 65 (S6: NO), it is determined whether or not the medal inserted is the value setting IC medal in S13. Here, this determination whether or not the inserted medal is the value setting IC medal 66 is conducted based on the kind of the game arcade ID and the password read out from the electronic tags 67, 74 in S2. Here, in the first embodiment, as the value setting IC medal, there exist four kinds of the 30 credit setting IC medal 70 for setting the value data to 30 credits, the 50 credit setting IC medal 71 for setting the value data to 50 credits, the 70 credit setting medal 72 for setting the value data to 70 credits and the 100 credit setting medal 73 for setting the value data to 100 credits. In S13, the kind of the value setting IC medal 66 is also determined.

And if it is determined that the medal inserted is the value setting IC medal 66 (S13: YES), the medal insertion number counter 103C is initialized in S14, thereafter the acceptance device CPU 101 changes in S15 the value data of the game IC medal at present stored in the medal value memory area 103A for the game IC medal in the RAM 103 to the value data read out from the value setting IC medal 66. Concretely, the value data are changed to 30 credits in case of the 30 credit setting IC medal 70, the value data are changed to 50 credits in case of the 50 credit setting IC medal 71, the value data are changed to 70 credits in case of the 70 credit setting IC medal 72 and the value data are changed to 100 credits in case of the 100 credit setting IC medal 73.

Next, in S6, display in the medal value display portion 61 is changed according to the credit number changed in S15. Therefore, according to the credit number displayed in the medal value display portion 61, the credit number at present, which is added every one game IC medal 65 is inserted, can be easily understood by the player and persons in the game arcade. Thereafter, procedure returns to S1 and the same processes are continuously repeated.

On the other hand, if it is determined that the medal inserted is not the value setting IC medal 66 (S13: NO), the medal inserted is returned from the medal return opening 63 in S17, thereafter procedure returns to S1.

As mentioned, according to the medal acceptance device 2 of the first embodiment, the value setting IC medal 66 is inserted in the medal acceptance device 2 and the value data of the game IC medal 65 (credit number added per one game IC medal) stored in the electronic tag 74 embedded in the value setting IC medal 66 is read out by the electronic tag reader 105 (S2). And the value data of the game IC medal 65 stored in the RAM 103 is set to the value data read out (the credit number “30”, “50”, “70”, “100”) (S8). And when the game IC medal is inserted so that the number thereof reaches to the number which is set, the value date of the game IC medal 65 is restored to the default value data (S11). Thereby, the value for one game IC medal 65 which is used in the game can be changed for a predetermined time by only inserting the value setting IC medal 66 without a large device or system. Therefore, the player does not need to carry many medals, and since game characteristic is variegated by changing the value of the medal, interest of the player for games can be increased. On the other hand, the game arcade can easily change the value of the medal at a voluntary timing in the game arcade without consuming cost. And it is not required to use the value setting IC medal 66 again and since the changed value data can be easily restored at a voluntary timing which is set by the restoration number setting switch 64, thereby convenience for the game arcade can be improved.

Further, the game arcade ID and the password are respectively stored in the game IC medal 65 and the value setting IC medal 66 and such game arcade ID and the password are verified with the game arcade ID and the password for confirmation stored in the ROM 102, thereby it is determined whether or not the medal is the proper IC medal (S3). Therefore, the forged medals and the medals bought or borrowed in the other game arcade can be surely determined and excluded (S10).

Further, the medal value display portion 61 displays the value of the game IC medal 65 (credit number added every one game IC medal is inserted) at present stored in the RAM 103 (S9), thereby the credit number, which is added every one game IC medal 65 is inserted, can be easily understood by the player and persons in the game arcade.

The present invention is not limited to the above embodiment and various modifications can be, of course, done within the scope of the present invention.

For example, in the first embodiment, although one medal acceptance device 2 is provided for one satellite, 5, one medal acceptance device 2 can be commonly utilized for a plurality of satellites 5.

And in the first embodiment, although the non-contact type electronic tag as the electronic tags 67, 74 is used, contact-type electronic tags may be utilized.

Further, in the first embodiment, although the electronic tag reader 105 for reading out the data of the electronic tags 67, 74 is provided in the medal acceptance device 2, it may be additionally provided an electronic tag writer for writing data in the electronic tags 67, 74. Thereby, in the medal acceptance device 2, new data can be written in the electronic tags 67, 74 and the data stored can be rewritten.

And although the default value restored in the first embodiment is fixed to 50 credits per one game IC medal 65, it may be conceivable that the default value is changed by independently providing a default value data change button.

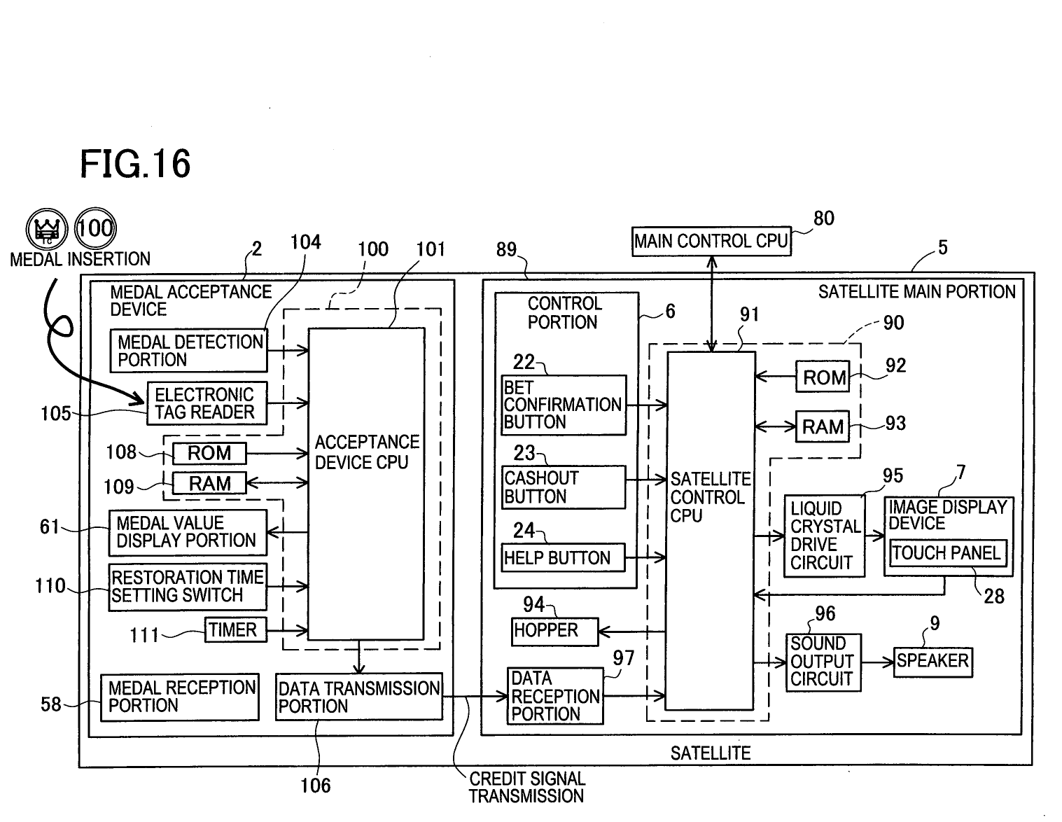

Next, the medal acceptance device according to the second embodiment will be described with reference to FIGS. 16 to 18. Here, the same number, sign and mark used in the medal acceptance device according to the first embodiment indicate the same elements in the medal acceptance device according to the second embodiment.

And the medal acceptance device and whole construction and control system of the roulette game machine having the medal acceptance device according to the second embodiment is substantially as same as the medal acceptance device 2 and the roulette game machine 1 having the medal acceptance device 2 according to the first embodiment. However, in the second embodiment the condition to restore the value data which is changed by the value setting IC medal 66 is different from that in the first embodiment, as mentioned later.

That is to say, although the condition to restore the value data changed in the first embodiment corresponds to the time when the number of the game IC medal 65 reaches to the predetermined number, in the second embodiment it is different from the first embodiment at the point that the changed value data is restored to the default value data when the predetermined time is elapsed since the value data is changed by the value setting IC medal 66.

Hereinafter, the medal acceptance device according to the second embodiment will be described. FIG. 16 is a block diagram schematically showing the control system of the satellite in which the medal acceptance device is provided of the second embodiment. Here, as for the control system of the satellite main body is as same as that in the first embodiment, therefore explanation thereof will be omitted.

Next, the medal acceptance device 2 attached to the main portion 89 will be described. The medal acceptance device 2 is constructed from an acceptance device control portion 100 and some periphery devices. Further, the acceptance device control portion 100 is constructed from a CPU 101 for the acceptance device, a ROM 108 and a RAM 109. The acceptance device CPU 101 conducts various processes based on data and programs stored in the ROM 108 and the RAM 109, and transmits the credit signal (mentioned later) to the satellite 5 on the basis of the result.

The ROM 108 is, for example, constructed form a semi-conductor memory and programs for realizing basic function of the medal acceptance device 2, the game arcade ID and password of the game IC medal 65 and the value setting IC medal 66 and the other various programs necessary for control of the medal acceptance device 2 are stored in the ROM 108. And the RAM 109 is a memory for temporarily storing various data calculated by the acceptance device CPU 101 and the value data (the credit number added per one game IC medal) of the game IC medal 65, the inserted medal number till the value data are restored, the counter counting the inserted medal number up to the present time since the value data are changed and the value data corresponding to the default.

Further, in the medal acceptance device 2, it is provided a medal reception portion 58 in which the game IC medal 65 and the value setting IC medal 66 are received.

And to the acceptance device CPU 101, a medal detection portion 104 is connected. The medal detection portion 104 detects medals inserted from the medal insertion slot 60 (see FIG. 4) and the acceptance device CPU 101 calculates medals inserted based on the medal detection signal output from the medal detection portion 104.

Further, to the acceptance device CPU 101, an electronic tag reader 105 is connected. The electronic tag reader 105 reads out the game arcade ID and password recorded in the game arcade ID memory area 67A and the password memory area 67B (see FIG. 7) of the electronic tag 67 embedded in the game IC medal 65 which is inserted. And the electronic tag reader 105 also reads out the game arcade ID, the password and the credit number set corresponding to the value per one game IC medal 65 all of which are respectively recorded in the game arcade ID memory area 74A, the password memory area 74B and the credit number memory area 74C (see FIG. 10) of the electronic tag 74 embedded in the value setting IC medal 66.

And each information read out is transmitted to the acceptance device CPU 101 and the acceptance CPU 101 compares the game arcade ID and the password read out from the game ID medal 65 with the confirmation ID and the password stored in the confirmation and password memory area 108A of the ROM 108, and determines whether or not the game ID medal 65 or the value setting IC medal 66 is proper. Further, the acceptance device CPU 101 changes the value data of the game IC medal 65 at present stored in the value data memory area 109A (see FIG. 18) of the RAM 109.

And to the acceptance device CPU 101, a restoration time setting switch 110 is connected. Here, in the medal acceptance device of the second embodiment, when a predetermined time is elapsed since the value data of the game IC medal 65 is changed, the value data of the game IC medal 65 hanged by the value setting IC medal 66 is restored to the default value data (stored in the default value data memory area 109C of the RAM 109), the default value data being the value data before the value data of the game IC medal 65 is changed. Ouch time is set by the restoration time setting switch 110.

The operation information of the restoration time setting switch 110 is transmitted to the acceptance device CPU 101 and the set time is stored in the restoration time memory area 109B of the RAM 109. On the other hand, the timer 111 for measuring the elapsing time is connected to the acceptance device CPU 101 and when the timer 111 measures the set time the value data of the game IC medal 65 stored in the value data memory area 109A is restored to the default value data (in the second embodiment, 50 credits per one game IC medal 65) stored in the default value data memory area 109C.

Further, the medal value display portion 61 is connected to the acceptance device CPU 101. The medal value display portion 61 displays the credit number added per one game IC medal 65 based on the value data of the game IC medal 65 at present stored in the medal value memory area 109A for the game IC medal 65 in the RAM 109.

Further, a data transmission portion 106 is connected to the acceptance device CPU 101. The data transmission portion 106 transmits the credit signal to the main portion 89. As mentioned, the credit signal is information concerning with the additional credit obtained by the acceptance device CPU 101 based on the value data of the game IC medal 65 at present stored in the RAM 109 when the game IC medal 65 is inserted in the medal acceptance device 2. And the satellite control CPU 91 increases the credit number stored in the RAM 93 based on the credit signal which is transmitted.

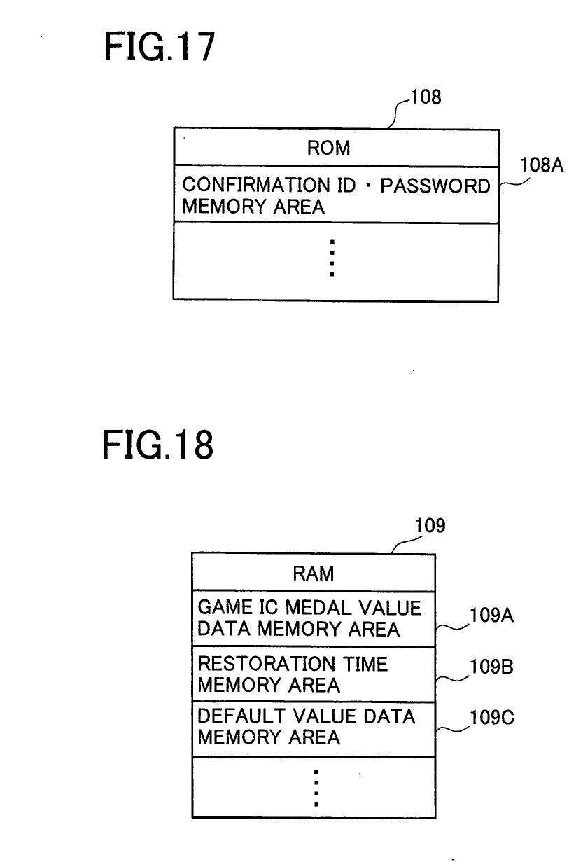

And as shown in FIG. 17, in the ROM 108 it is formed a memory area 108A for confirmation ID and password in which it is stored a confirmation ID to confirm whether or not an inserted medal is a proper IC medal and a password.

And as shown in FIG. 18, in the RAM 109 it is formed the value data memory area 109A for the game IC medal 65 in which the value data indicating the value of the game IC medal 65 (credit number added per one game IC medal 65) at present are stored, the restoration time memory area 109B for storing the till the changed time is restored and the default value data memory area 109C for storing the default value data to which the value data are restored.

As mentioned, according to the medal acceptance device 2 of the second embodiment, the value setting IC medal 66 is inserted in the medal acceptance device 2 and the value data of the game IC medal 65 (credit number added per one game IC medal 65) stored in the electronic tag 74 embedded in the value setting IC medal 66 is read out by the electronic tag reader 105. And the value data of the game IC medal 65 stored in the RAM 109 is set to the value data read out (the credit number “30”, “50”, “70”, “100”). And after the predetermined time is elapsed since the value data is changed, the value data are restored to the default value data of the game IC medal 65 is restored to the default value data. Thereby, the value for one game IC medal 65 which is used in the game can be changed for a predetermined time by only inserting the value setting IC medal 66 without a large device or system. Therefore, the player does not need to carry many medals, and since game characteristic is variegated by changing the value of the medal, interest of the player for games can be increased. On the other hand, the game arcade can easily change the value of the medal at a voluntary timing in the game arcade without consuming cost. And it is not required to use the value setting IC medal 66 again and since the changed value data can be easily restored at a voluntary timing which is set by the restoration time setting switch 110, thereby convenience for the game arcade can be improved.

The present invention is not limited to the medal acceptance device and a game using the device. Functions and mechanisms described herein can be applied to chips for table games (e.g. black jack, baccarat, roulette game or the like).

1. A medal acceptance device having a medal detection device for detecting a game medal inserted from a medal insertion slot and a data memory device for storing first value data corresponding to a first value of the game medal,
the medal acceptance device comprising:
a value setting medal having a memory medium in which second value data different from the first value data stored in the data memory device are stored;
a data detection device for detecting the second value data stored in the memory medium of the value setting medal inserted from the medal insertion slot;
a data change device for changing the first value data stored in the data memory device to the second value data when the second value data of the value setting medal are detected by the data detection device; and
a data restoration device for restoring the second value data changed by the data change device and stored in the data memory device to the first value data after the first value data are changed to the second value data by the data change device.

2. The medal acceptance device according to claim 1, wherein the data restoration device restores the second value data stored in the data memory device to the first value data when a predetermined number of the game medals are detected by the medal detection device after the first value data are changed to the second value data by the data change device.

3. The medal acceptance device according to claim 2, further comprising:
a medal number change device for changing the predetermined number of the game medals.

4. The medal acceptance device according to claim 1, wherein the data restoration device restores the second value data stored in the data memory device to the first value data when a predetermined time elapses after the first value data are changed to the second value data by the data change device.

5. The medal acceptance device according to claim 4, further comprising:
a time change device for changing the predetermined time.

6. The medal acceptance device according to claim 1, wherein the game medal has a memory medium in which the first value data are stored.

7. The medal acceptance device according to claim 6, wherein the memory medium of the game medal stores first information for discriminating the game medal and the memory medium of the value setting medal stores second information for discriminating the value setting medal.

8. The medal acceptance device according to claim 7, further comprising:
an information memory device for storing third information to confirm the first information or the second information;
an information detection device for detecting the first information stored in the memory medium of the game medal or the second information stored in the memory medium of the value setting medal;
a comparison device for comparing the first information or the second information with the third information; and
a determination device for determining whether the first information or the second information is true with the third information based on a result by the comparison device.

9. The medal acceptance device according to claim 7, further comprising:
a display device for displaying the first information or the second information.

10. The medal acceptance device according to claim 1, wherein the game medal has an electronic tag therein.

11. The medal acceptance device according to claim 10, wherein the electronic tag has an ID memory area for storing an ID indicating a place in which the game medal is used and a password memory area for storing a password to confirm whether or not the game medal is true.

12. The medal acceptance device according to claim 1, wherein the value setting medal has an electronic tag therein.

13. The medal acceptance device according to claim 12, wherein the electronic tag has an ID memory area for storing an ID indicating a place in which the value setting medal is used, a password memory area for storing a password to confirm whether or not the value setting medal is true and a credit number memory area for storing a credit number which is utilized to set the first value of the game medal.

14. The medal acceptance device according to claim 13, wherein a number corresponding to the credit number is indicated on one surface of the value setting medal.

15. The medal acceptance device according to claim 1, wherein plural kinds of the value setting medals are utilized, each memory medium of the value setting medals storing different second value data with each other.
